(19) United States
(12) Patent Application Publication
(10) Pub. No.: US 2015/0270031 A1
(43) Pub. Date: Sep. 24, 2015

(54) POWER CABLE, IMAGING APPARATUS AND ELECTRONIC DEVICE INCLUDING THE POWER CABLE

(71) Applicant: SAMSUNG ELECTRONICS CO., LTD., Suwon-si (KR)

(72) Inventors: Sung Yong JOO, Yongin-si (KR); Jin Hyung LEE, Anyang-si (KR); Gil Yong CHANG, Suwon-si (KR)

(73) Assignee: SAMSUNG ELECTRONICS CO., LTD., Suwon-si (KR)

(21) Appl. No.: 14/661,024

(22) Filed: Mar. 18, 2015

(30) Foreign Application Priority Data
Mar. 18, 2014 (KR) 10-2014-0031483

(51) Int. Cl. H01B 9/00; H01R 13/70

(52) U.S. Cl. CPC H01B 9/006; H01R 13/70

(57) ABSTRACT

A power cable, and an imaging apparatus and an electronic device including the power cable are provided. Power and grounding of the imaging apparatus and the electronic device may be controlled even while the power cable is plugged into a power outlet. The power cable includes a power input including a first input terminal, a second input terminal, and a first ground terminal; a power output including a first output terminal, a second output terminal, and a second ground terminal connected to the first input terminal, the second input terminal, and the first ground terminal, respectively; a first switch that may disconnect the first input terminal from the first output terminal; and a second switch that may disconnect the first ground terminal from the second ground terminal.

### CROSS-REFERENCE TO RELATED APPLICATION(S)

This application claims priority from Korean Patent Application No. 10-2014-0031483, filed on Mar. 18, 2014, in the Korean Intellectual Property Office, the entire disclosure of which is incorporated herein by reference.

### BACKGROUND

1. Field

Apparatuses and methods consistent with exemplary embodiments relate to a power cable, and to an imaging apparatus and an electronic device that may include the power cable.

2. Description of Related Art

An imaging apparatus may refer to any type of device involved in a process of displaying an image on a screen. An imaging apparatus may include an image signal generator for generating an image signal of a domain desired to be imaged, a signal transmitter for transmitting the image signal, a signal receiver for receiving the image signal, a processor for processing the received image signal into an image, and a display for displaying the image on the screen.

The imaging apparatus may be driven by a power supply. Power is typically transmitted to customers who subscribe to power companies that supply power through power outlets of the respective customers. To this end, the imaging apparatus may include a power cable that plugs into a power outlet to charge or otherwise power the imaging apparatus.

With the power cable plugged into the power outlet, the imaging apparatus may be turned on. However, while with the power cable is separated or otherwise unplugged from the power outlet, the imaging apparatus may be turned off.

### SUMMARY

Exemplary embodiments overcome the above disadvantages and other disadvantages not described above. Also, an exemplary embodiment is not required to overcome the disadvantages described above, and an exemplary embodiment may not overcome any of the problems described above.

One or more exemplary embodiments provide a power cable, an imaging apparatus, and an electronic device including the power cable, with which power and grounding of the imaging apparatus may be controlled even while the power cable is plugged into a power outlet.

According to one or more exemplary embodiments, there is provided a power cable including a power input including a first input terminal, a second input terminal, and a first ground terminal; a power output including a first output terminal, a second output terminal, and a second ground terminal, which are connected to the first input terminal, the second input terminal, and the first ground terminal, respectively; a first switch that disconnects the first input terminal from the first output terminal; and a second switch that disconnects first ground terminal from the second ground terminal.

The first switch may be included in the power input.

The second switch may be included in the power output.

At least one of the first switch and the second switch may correspond to a slide switch that may interrupt the connection.

The power input may have a first input terminal applied with a varying electric potential.

The power cable may further include a connector including a first connection line connecting the first input terminal and the first output terminal; a second connection line connecting the second input terminal and the second output terminal; and a ground line connecting the first ground terminal and the second ground terminal.

The first switch may disconnect the first input terminal from the first output terminal by interrupting the first connection line.

The second switch may disconnect the first ground terminal from the second ground terminal by interrupting the ground line.

According to an aspect of another exemplary embodiment, there is provided an imaging apparatus including a power cable including a power input having a first input terminal, a second input terminal, and a first ground terminal; a power output having a first output terminal, a second output terminal, and a second ground terminal, which are connected to the first input terminal, the second input terminal, and the first ground terminal, respectively; a first switch for disconnecting the first input terminal from the first output terminal; and a second switch for disconnecting the first ground terminal from the second ground terminal; and a main unit connected to the power output of the power cable to be supplied with power through the power cable.

The first switch may be included in the power input of the power cable.

The second switch may be included in the power output of the power cable.

At least one of the first switch and the second switch may correspond to a slide switch for interrupting the connection.

The power input may have a first input terminal applied with a varying electric potential.

The power cable may further include a connector including a first connection line connecting the first input terminal and the first output terminal; a second connection line connecting the second input terminal and the second output terminal; and a ground line connecting the first ground terminal and the second ground terminal.

The first switch may disconnect the first input terminal from the first output terminal by interrupting the first connection line.

The second switch may disconnect the first ground terminal from the second ground terminal by interrupting the ground line.

According to an aspect of another exemplary embodiment, an electronic device is provided including a power cable including a power input having a first input terminal, a second input terminal, and a first ground terminal; a power output having a first output terminal, a second output terminal, and a second ground terminal, which are connected to the first input terminal, the second input terminal, and the first ground terminal, respectively; a first switch for disconnecting the first input terminal from the first output terminal; and a second switch for disconnecting the first ground terminal from the second ground terminal; and a main unit device connected to the power output of the power cable to be supplied with power through the power cable.

The first switch may be included in the power input of the power cable.

The second switch may be included in the power output of the power cable.

At least one of the first switch and the second switch may correspond to a slide switch for interrupting the connection.

The power input may have a first input terminal applied with a varying electric potential.

The power cable may further include a connector including a first connection line connecting the first input terminal and the first output terminal; a second connection line connecting the second input terminal and the second output terminal; and a ground line connecting the first ground terminal and the second ground terminal.

The first switch may disconnect the first input terminal from the first output terminal by interrupting the first connection line.

The second switch may disconnect the first ground terminal from the second ground terminal by interrupting the ground line.

Other aspects, advantages, and salient features of the disclosure will become apparent to those skilled in the art from the following detailed description, which, taken in conjunction with the annexed drawings, provide exemplary embodiments of the disclosure.

### BRIEF DESCRIPTION OF THE DRAWINGS

The above and other features and advantages of the exemplary embodiments will become more apparent by describing the exemplary embodiments with reference to the attached drawings in which:

FIG. 1 is a front perspective view of an imaging apparatus, according to an exemplary embodiment;

FIGS. 2A and 2B illustrate a power cable that is connected to a power outlet and a main unit, according to an exemplary embodiment;

FIG. 3 illustrates a power cable, according to an exemplary embodiment;

FIG. 4A is a front perspective view of a power input of a power cable, according to an exemplary embodiment;

FIG. 4B is a side perspective view of the power input of the power cable, according to an exemplary embodiment;

FIGS. 5A and 5B illustrate operations of a first switch of a power cable, according to exemplary embodiments;

FIG. 6A is a front perspective view of a power output of a power cable, according to an exemplary embodiment;

FIG. 6B is a side perspective view of the power output of the power cable, according to an exemplary embodiment;

FIG. 7 illustrates the interior of a connector of a power cable, according to an exemplary embodiment;

FIG. 8 illustrates multiple power cables connected to Large Format Displays (LFDs), according to an exemplary embodiment;

FIG. 9 illustrates an example in which multiple imaging apparatuses are interconnected, according to an exemplary embodiment; and

FIG. 10 illustrates controlling a power supplying path and a ground path of an imaging apparatus, according to an exemplary embodiment.

Throughout the drawings, like reference numerals will be understood to refer to like parts, components, and structures.

### DETAILED DESCRIPTION

The present disclosure will now be described more fully with reference to the accompanying drawings, in which exemplary embodiments of the disclosure are shown. The disclosure may, however, be embodied in many different forms and should not be construed as being limited to the exemplary embodiments set forth herein; rather, these exemplary embodiments are provided so that this disclosure will be thorough and complete, and will fully convey the concept of the disclosure to those skilled in the art.

Like reference numerals in the drawings denote like elements, and thus, their description will be omitted. In the description of the present disclosure, if it is determined that a description of a commonly-used technology, structure, or feature related to one or more exemplary embodiments of the present disclosure may unnecessarily obscure the subject matter described herein, the description will be omitted. It will be understood that, although the terms first, second, third, and the like, may be used herein to describe various elements, components, regions, layers and/or sections, these elements, components, regions, layers and/or sections should not be limited by these terms. These terms are only used to distinguish one element, component, region, layer or section from another region, layer or section.

Exemplary embodiments of a power cable, an imaging apparatus including the power cable, and an electronic device including the imaging apparatus are further described herein with reference to accompanying drawings.

An imaging apparatus may refer to a device or other apparatus that is involved in processes used to display an image on a screen. The imaging apparatus may include an image signal generator for generating an image signal of a domain desired to be imaged, an image signal transmitter for transmitting the image signal, an image signal receiver for receiving an image signal, an image processor for processing the received image signal into an image, and/or an image display for displaying the image on the screen.

For example, the imaging apparatus may be a display device such as a television, a monitor, a tablet, a mobile phone, an appliance, a large format display including multiple displays, and the like. Alternatively, the imaging apparatus may be an apparatus that receives an image signal and connects to a display such as a set-top box, a game console, and the like.

The imaging apparatus may perform at least two functions of the image signal generator, the image signal transmitter, the image signal receiver, the image signal processor, and the image display. That is, the imaging apparatus may perform multiple functions in a series of processes to display an image on the screen.

For example, the imaging apparatus may receive an image signal, process the image signal into an image, and display the image on the screen.

For example, the imaging apparatus may include or may be any device that may be used to display an image of a domain to be imaged on the screen. In the following description, assume an imaging apparatus is driven with power.

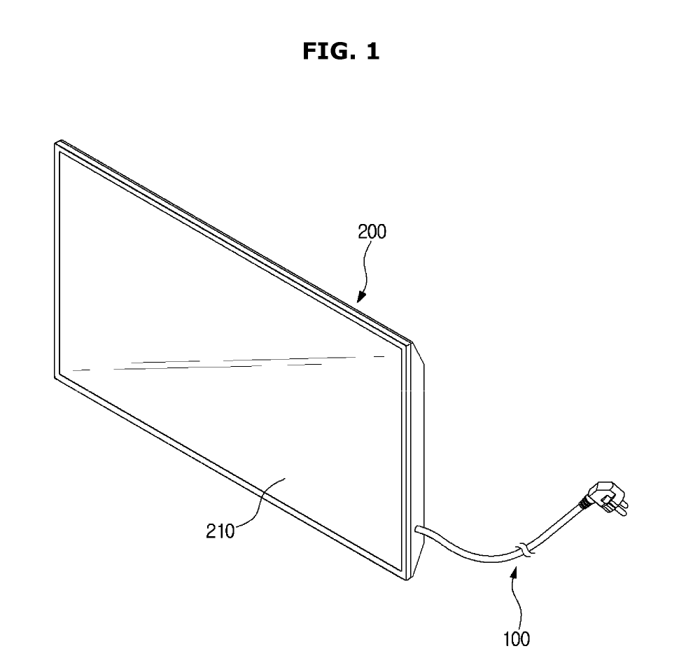

FIG. 1 is a front perspective of an imaging apparatus, according to an exemplary embodiment.

Referring to the example of FIG. 1, the imaging apparatus includes a power cable 100, and a main unit 200 connected to an output of the power cable 100 such that it may be supplied with power via the power cable 100. For example, the main unit 200 may be a display, a television, a computer monitor, a camera, a tablet, an appliance, a multi-panel display, a set-top box, a game console, and the like.

The main unit 200 may perform the main functions of the imaging apparatus. For example, if the imaging apparatus is the image signal transmitter, the main unit 200 may generate an image signal of an area to be imaged and transmit the generated image signal. If the imaging apparatus is the image signal receiver, the main unit 200 may receive an image signal. As another example, if the imaging apparatus is the image processor, the main unit 200 may process a received image signal into an image. Also, if the imaging apparatus is an image display, the main unit 200 may display an image on the screen.

Assume in an example that the imaging apparatus is a display device as shown in FIG. 1. Here, the main unit 200 includes a display screen 210 for displaying an image.

The power cable 100 may supply power to the main unit 200. The other end of the power cable 100 may be plugged into a power outlet and may be supplied with power from a power source of the power outlet. The other end of the power cable 100 may be connected to the main unit 200 to supply the power.

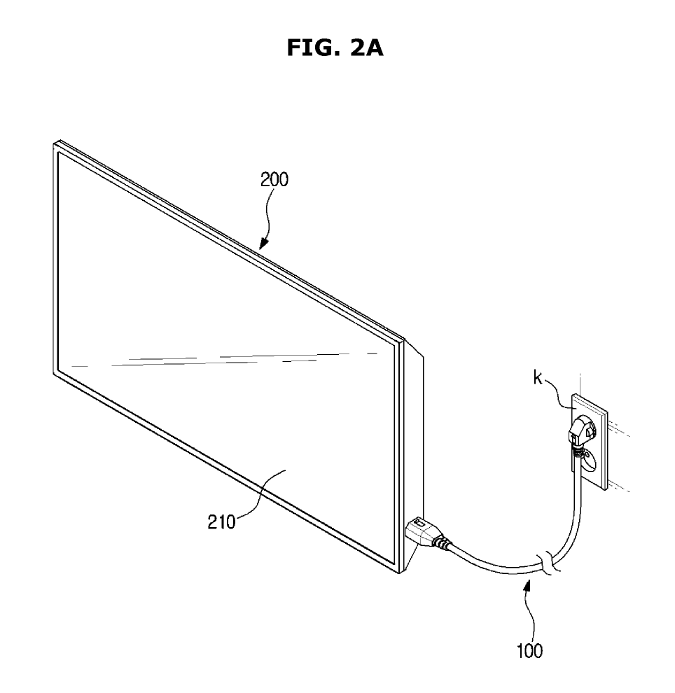

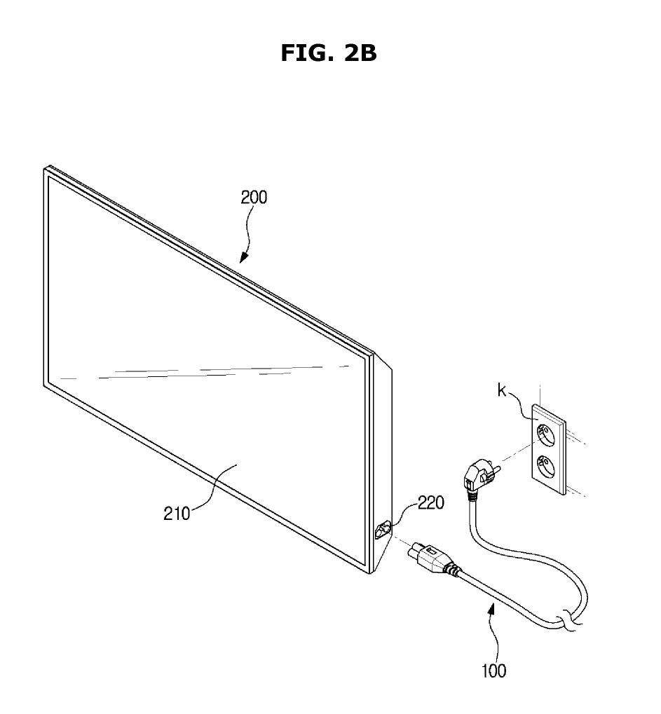

FIGS. 2A and 2B illustrate a power cable that is connected to a power outlet and a main unit, according to an exemplary embodiment.

Referring to FIGS. 2A and 2B, an end of the power cable 100 may have a form that is capable of being plugged into a power outlet k. For example, if the power outlet has an alcoved shape or a recessed shape, an end of the power cable 100 may have a protruding shape such that it may be plugged into the power outlet k. On the contrary, if the power outlet has a protruding shape, an end of the power cable 100 may have the alcoved shape or the recessed shape such that it may be plugged into the power outlet k.

The other end of the power cable 100 may be connected to the main unit 200. In an example of the imaging apparatus, the power cable 100 and the main unit 200 may be integrated in one piece. In this example, the other end of the power cable 100 may be fixedly connected to the main unit 200.

Alternatively, as shown in FIGS. 2A and 2B, the other end of the power cable 100 may be detachable from the main unit 200. That is, the other end of the power cable 100 may have a form that may be connected to a connector 220 of the main unit 200. As a non-limiting example, if the connector 220 has an alcoved shape, the other end of the power cable 100 may have a protruding shape to connect to the connector 220, or if the connector 220 has a protruding shape, the other end of the power cable 100 may have an alcoved shape to connect to the connector 220.

If the power cable 100 is detachable from the main unit 200, the power cable 100 may be connected to another main unit that has a same form that can be connected to the power cable 100. Accordingly, when the power cable 100 is detachable from the main unit 200, compatibility of the power cable 100 may be increased.

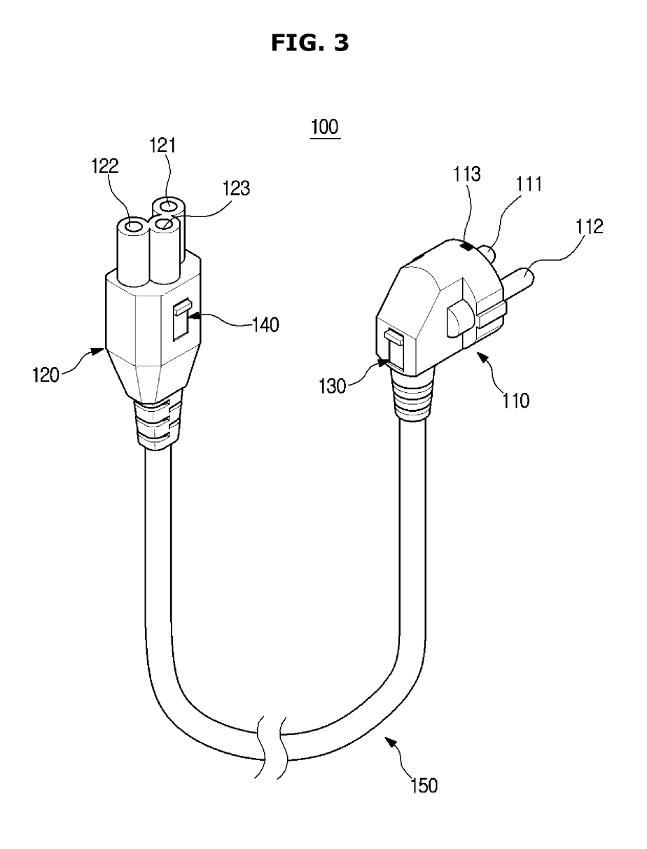

FIG. 3 illustrates a power cable, according to an exemplary embodiment.

Referring FIG. 3, the power cable 100 includes a power input 110 that has a first input terminal 111, a second input terminal 112, and a first ground terminal 113. The power cable 100 also includes a power output 120 that has a first output terminal 121, a second output terminal 122, and a second ground terminal 123, which are connected to the first input terminal 111, the second input terminal 112, and the first ground terminal 113, respectively. The power cable 100 further includes a first switch 130 that may disconnect the first input terminal 111 from the first output terminal 121, and a second switch 140 that may disconnect the first ground terminal 113 from the second ground terminal 123.

As shown in FIG. 3, the power input 110 may be arranged at an end of the power cable 100. In the power input 110, a time-varying electric potential may be applied to the first input terminal 111 and a constant potential may be applied to the second input terminal 112. Here, the first ground terminal 113 may discharge a leakage current to the outside.

For example, the first input terminal 111 may be connected to a live terminal of the power outlet k, and the second input terminal 112 may be connected to a neutral terminal of the power outlet k. In this example, the live terminal of the power outlet k may be arranged at an end of a live line, and the neutral terminal may be arranged at an end of a neutral line.

Accordingly, a potential applied to the first input terminal 111 may vary in magnitude and direction with time, however, a potential applied to the second input terminal 112 may remain constant. For example, the potential applied to the first input terminal 111 may have a sinusoidal form, and the potential applied to the second input terminal 112 may have a zero, i.e. 0 voltage (V).

The first ground terminal 113 of the power input 110 may be connected to a ground terminal of the power outlet k. Because the ground terminal of the power outlet k may be connected to the earth ground, the leakage current may be discharged safely from the first ground terminal 113 of the power input 110 to the earth via the ground terminal of the power outlet k.

In the power output 120, the first output terminal 121 is connected to the first input terminal 111 of the power input 110. Also, in the power output 120 the second output terminal 122 is connected to the second input terminal 112 of the power input 110, and the second ground terminal 123 is connected to the first ground terminal 113 of the power input 110.

In this example, because the first input terminal 111 and the first output terminal 121 are electrically connected to each other, the first output terminal 121 may have an output that is similar to an input that is applied to the first input terminal 111. That is, the first output terminal 121 may output potentials that vary in magnitude and direction with time. For example, if a potential of a sinusoidal waveform is applied to the first input terminal 111, the first output terminal 121 may output a potential of the sinusoidal waveform.

Because the second input terminal 112 and the second output terminal 122 are electrically connected to each other, the second output terminal 122 may have an output that is similar to an input that is applied to the second input terminal 112. That is, the second output terminal 122 may output a constant potential. For example, if a potential of 0 V is applied to the second input terminal 112, the second output terminal 122 may output the potential of 0 V.

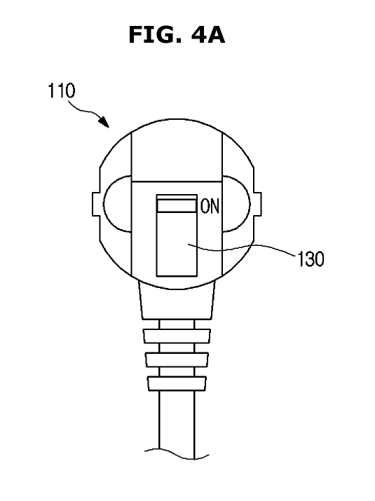

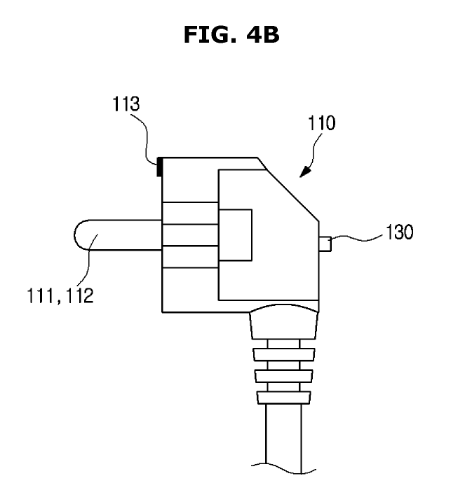

FIG. 4A is a front perspective view of a power input of a power cable, according to an exemplary embodiment, and FIG. 4B is a side perspective view of the power input of the power cable, according to an exemplary embodiment.

Referring to FIGS. 4A and 4B, the first switch 130 may disconnect the first input terminal 111 from the first output terminal 121 and may be arranged at an end of the power input 110.

For example, if the first switch 130 is on, the first input terminal 111 may be connected to the first output terminal 121. Accordingly, forcing the first switch 130 to be on may enable a potential applied to the first input terminal 111 to be output through the first output terminal 121. In response, power may be supplied to the main unit 200 connected to the power cable 100.

In contrast, when the first switch 130 is off, the first input terminal 111 may be disconnected from the first output terminal 121. Accordingly, a potential input to the first input terminal 111 may not be output from the first output terminal 121, and as a result, power is not supplied to the main unit 200.

It should also be appreciated that the first switch 130 may be modified in various ways as long as it is able to disconnect the first input terminal 111 from the first output terminal 121. For example, the first switch 130 may be implemented as a toggle switch. As other examples, the first switch 130 may be implemented as a locker switch, a push-button switch, a touch switch, a slide switch, and the like.

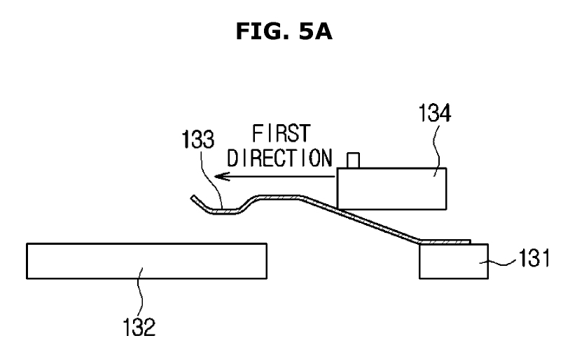

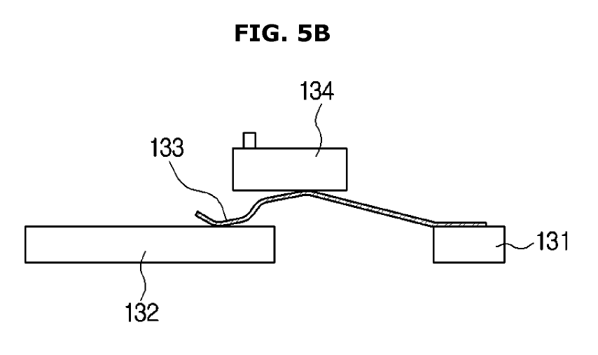

FIGS. 5A and 5B illustrate operations of a first switch of a power cable, according to exemplary embodiments. In the examples of FIGS. 5A and 5B, the first switch 130 is implemented as a slide switch.

According to one or more exemplary embodiments, the first switch 130 may include a first switch terminal 131 connected to the first input terminal 111, a second switch terminal 132 connected to the first output terminal 121, a connector 133 that has an end connected to any of the first switch terminal 131 and the second switch terminal 132 while the other end is connected to the other one of the first switch terminal 131 and the second switch terminal 132. The first switch 130 may also include a slider 134 that is movable such that the connector 133 is connected to the other one of the first switch terminal 131 and the second switch terminal 132.

Referring to FIG. 5A, an end of the connector 133 of the first switch is connected to the first switch terminal 131. Before the slider 134 moves in a first direction, the other end of the connector 133 is not connected to the second switch terminal 132. Accordingly, the first switch terminal 131 and the second switch terminal 132 may be electrically disconnected from each other.

When the slider 134 is moved in the first direction to press or otherwise push the connector 133, the other end of the connector 133 may be connected to the second switch terminal 132. As shown in FIG. 5B, the connector 133 may connect the first switch terminal 131 and the second switch terminal 132 electrically. Accordingly, the first input terminal 111 connected to the first switch terminal 131 may be electrically connected to the first output terminal 121 connected to the second switch terminal 132, thus creating an electrical connection between the first and second switch terminals 131 and 132.

As shown in FIGS. 5A and 5B, with the first switch 130 is a slide switch, the first input terminal 111 may be disconnected from the first output terminal 121 by simple movement of the slider 134. If the user mistakenly presses and manipulates the first switch 130 while plugging the power input 110 into the power outlet, connection between the first input terminal 111 and the first output terminal 121 may change. However, according to various aspects, by using a slide switch for the first switch 130 this may prevent the malfunction of the first switch 130 because the direction in which the user plugs the power input 110 into the power outlet may be different from the first direction in which the slider 134 of the first switch 130 moves.

Thus far, an example in which the first switch 130 disconnects the first input terminal 111 from the first output terminal 121 has been described. In the following example, the second switch 140 that disconnects the first ground terminal 113 from the second ground terminal 123 is described.

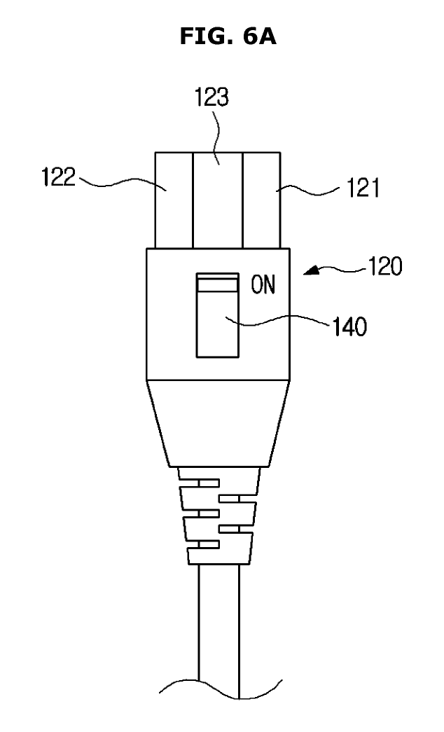

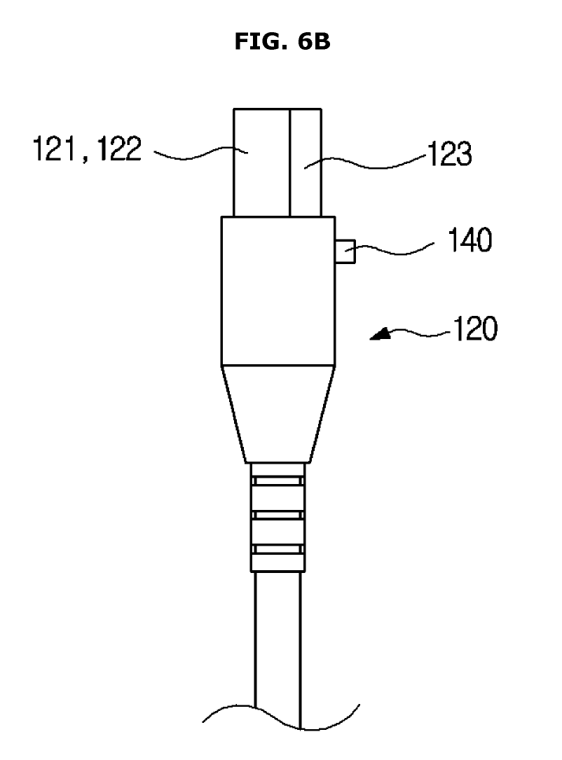

FIG. 6A is a front perspective view of a power output of a power cable, according to an exemplary embodiment of the present disclosure, and FIG. 6B is a side perspective view of the power output of the power cable, according to an exemplary embodiment.

Referring to the examples of FIGS. 6A and 6B, the second switch 140 for disconnecting the second ground terminal 123 from the first ground terminal 113 is arranged at an approximate end of the power output 120.

When the second switch 140 is on, the second ground terminal 123 may be connected to the first ground terminal 113. Accordingly, when the second switch 140 is on a leakage current from the main unit 200 may be delivered to the first ground terminal 113 through the second ground terminal 123. As a result, the leakage current may be discharged to the earth ground connected to the first ground terminal 113.

In contrast, when the second switch 140 is off, the second ground terminal 123 and the first ground terminal 113 may be disconnected from each other. Accordingly, a discharging path for the leakage current from the main unit 200 to the ground may be prevented.

It should be appreciated that the second switch 140 may be modified in various ways just as long as it is capable of disconnecting the second ground terminal 123 from the first ground terminal 113. Like the first switch 130, the second switch 140 may be implemented with a toggle switch, a locker switch, a push-button switch, a touch switch, and the like. In addition, as shown in the examples of FIGS. 6A and 6B, the second switch 140 may be implemented as a slide switch.

Turning back to FIG. 3, the power cable 100 may further include a connector 150 such as a cable that electrically connects the power input 110 and the power output 120.

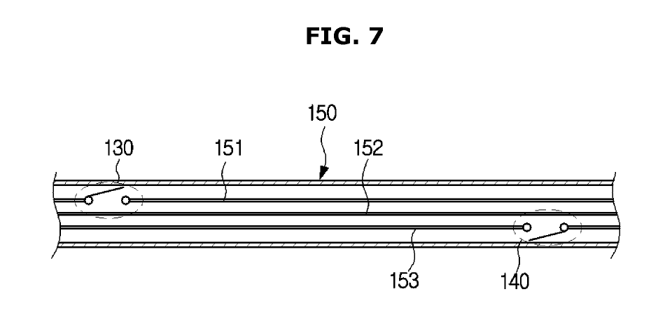

FIG. 7 illustrates an example of the interior of the connector 150 of a power cable, according to an exemplary embodiment.

For example, as shown in FIG. 7, the connector 150 may include a first connection line 151 connecting the first input terminal 111 and the first output terminal 121, a second connection line 152 connecting the second input terminal 112 and the second output terminal 122, and a ground line 153 connecting the first and second ground terminals 113 and 123. It should be appreciated that the arrangement of the connection lines is not limited to the example of FIG. 7, and may be arranged in any desired manner.

FIG. 7 illustrates the interior of the connector 150 of a power cable, according to an exemplary embodiment.

In this example, the first connection line 151 is used to electrically connect the first input terminal 111 and the first output terminal 121. The first connection line 151 may be cut off or otherwise interrupted by the first switch 130. For example, the user may turn off the first switch 130 to interrupt the first connection line 151, thereby preventing power from being supplied to the main unit 200 through the first connection line 151.

The second connection line 152 may be used to electrically connect the second input terminal 112 and the second output terminal 122. As shown in FIG. 7, without a switch that cuts off the second connection line 152, the second connection line 152 may continuously connect the second input terminal 112 and the second output terminal 122.

The ground line 153 may be used to electrically connect the second ground terminal 123 and the first ground terminal 113. The ground line 153 may also be cut off by the second switch 140. For example, the user may turn off the second switch 140 to cut off the discharging path of the leakage current.

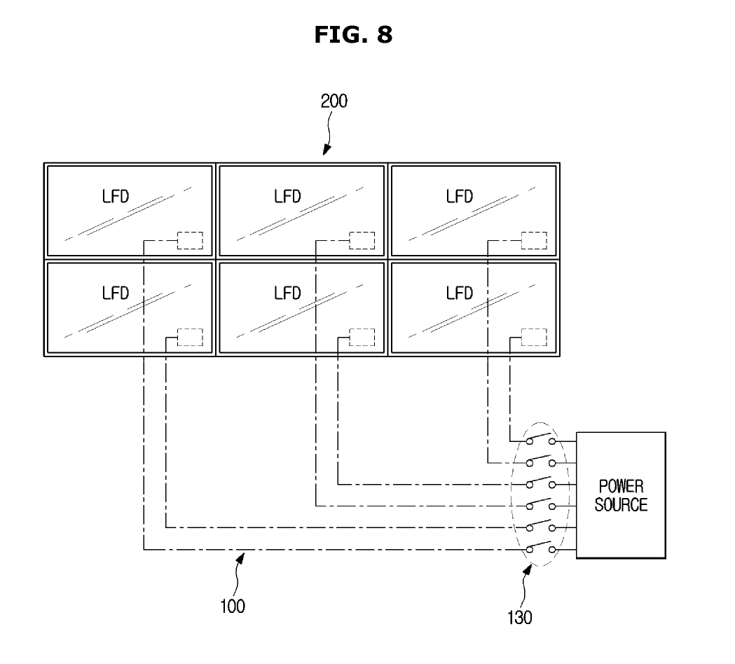

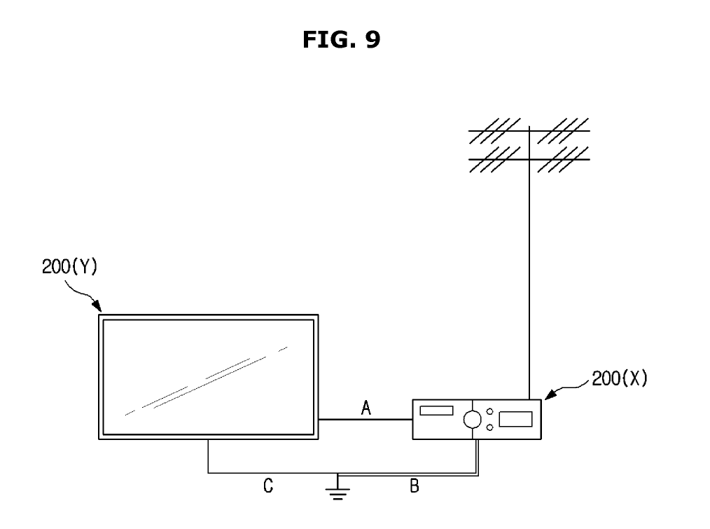

According to one or more of the exemplary embodiments, both the power supplying path and the leakage current discharging path may be controlled at the same time. For example, the first switch 130 for controlling the power supplying path may be arranged in the power input 110 and plugged into a power outlet, and the second switch 140 for controlling the leakage current discharging path may be arranged in the power output 120 and be connected to the main unit 200. Examples of the effects of the configuration of the power cable 100 are described with respect to FIGS. 8 and 9.

FIG. 8 illustrates multiple power cables that are each connected to Large Format Displays (LFDs), according to an exemplary embodiment.

An LFD is an image display device, and multiple LFDs may be used to display a single image on a plurality of the screens, thereby being widely used, for example, in the field of advertisements. Even though the multiple LFDs display a single image, each LFD should be supplied with power. Accordingly, each LFD include a power cable, such as the power cable 100 that is used to supply power.

An LFD also uses a drive current for driving the display. It may not matter in driving a single LFD, but an overload of the LFD may occur in applying driving currents to the multiple LFDs simultaneously. The overload may occur because, for example, the driving current to turn on an LFD is far greater than the current applied to the LFD after the LFD is already turned on.

According to one or more exemplary embodiments, to prevent an overload of an LFD, the user may control the first switch 130 arranged in the power cable 100 to be plugged into the power outlet as shown in FIG. 8. For example, by sequentially turning on the multiple first switches 130 arranged in respective power cables 100 corresponding to the multiple LFDs, concurrent supply of the driving currents may not occur. Accordingly, overload of the LFD may be prevented.

FIG. 9 illustrates multiple imaging apparatuses that are interconnected, according to an exemplary embodiment.

As described in one or more exemplary embodiments, multiple imaging apparatuses may be electrically interconnected. For example, two imaging apparatuses, such as a set-top box 200X and a television 200Y, may be electrically interconnected such that the set-top box 200X receives an image signal from an outside and forwards the image signal to the television 200Y. As a non-limiting example, the set-top box 200X and the television 200Y may be electrically connected by a High Definition Multimedia Interface (HDMI) cable A.

In this example, an electric potential of the set-top box 200X may be higher than that of the television 200Y. As a result, a leakage current generated in the set-top box 200X may not be discharged along a ground path B of the set-top box 200X but may flow along the HDMI cable A to be discharged through a ground path C of the television 200Y which has a lower potential. When the leakage current flows in the HDMI cable A, heat may be generated in the HDMI cable A. The generated heat may cause damage to at least one of the HDMI cable A and to the television 200Y.

To prevent this damage, the ground path C of the television 200Y may be blocked off or otherwise interrupted. For example, turning off the second switch 140 of the power cable 100 connected to the main unit 200 may disconnect the second ground terminal 123 from the first ground terminal 113. Accordingly, the leakage current of the set-top box 200X may be discharged along the ground path B of the set-top box 200X to the outside instead of the ground path C.

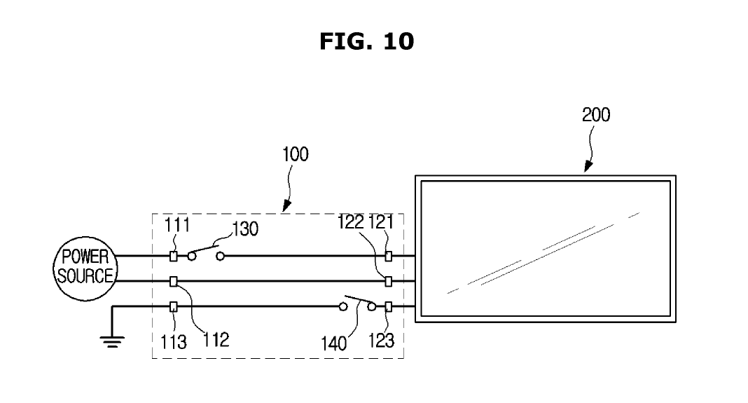

FIG. 10 illustrates controlling a power supplying path and a ground path of an imaging apparatus, according to an exemplary embodiment. An example of a method for controlling power and leakage current by means of the power cable 100 is described in connection with FIG. 10.

Referring to FIG. 10, power is supplied to the first input terminal 111 and the second input terminal 112 arranged in the power input 110 of the power cable 100. For example, the first input terminal 111 may receive a time-varying potential while the second input terminal 112 may receive a time-invariant constant potential.

In this example, the first input terminal 111 delivers the time-varying potential to the first output terminal 121 of the power output 120 through the first connection line 151, and the second input terminal 112 delivers the constant potential to the second output terminal 121 of the power output 120 through the second connection line 152. Accordingly, power may be supplied to the main unit 200 through the first input terminal 111 and the second input terminal 112.

To disconnect the first input terminal 111 from the first output terminal 121, the first switch 130 may be used to cut off the first connection line 151. In addition, the user may supply power to the main unit 200 by turning on the first switch 130 if the user intends to supply power to the main unit 200.

A leakage current generated in the main unit 200 should be discharged to the earth ground. In this example, the leakage current of the main unit 200 may be delivered to the second ground terminal 123 of the power output 120.

In this example, the leakage current may flow to the first ground terminal 113 of the power input 110 through the ground line 153. Also, the first ground terminal 123 may discharge the leakage current to the earth through the ground terminal of the power outlet.

In this example, to disconnect the first ground terminal 113 from the second ground terminal 123, the second switch 140 may be used to interrupt the ground line 153. Should the user desire, the user may turn on the second switch 140 if the user intends to discharge the leakage current to the earth through the power cable 100.

Thus far, it has been assumed that the first switch 130 is used to disconnect the first input terminal 111 from the first output terminal 121. However, this is merely an exemplary embodiment of the power cable 100. As another example, it is possible for the first switch 130 to be used to disconnect the second input terminal 112 from the second output terminal 122, and the like.

Furthermore, while exemplary embodiments herein have described that the power cable 100 is connected to an imaging apparatus to supply power, it may be connected and supply power to any electronic devices that use power.

According to one or more exemplary embodiments, power and grounding of an imaging apparatus or other electrical device may be easily controlled by means of a switch while a power cable is plugged into a power outlet.

For example, a power switch frequently manipulated by the user may be included in a part of the power cable which is connected to the power outlet while arranging a ground switch in a part connected to a main unit, thus, improving user convenience.

Several embodiments have been described, but a person of ordinary skill in the art will understand and appreciate that various modifications can be made without departing the scope of the present disclosure. Thus, it will be apparent to those ordinary skilled in the art that the disclosure is not limited to the exemplary embodiments described, which have been provided only for illustrative purposes only.

What is claimed is:

1. A power cable comprising:
a power input comprising a first input terminal, a second input terminal, and a first ground terminal;
a power output comprising a first output terminal, a second output terminal, and a second ground terminal, which are connected to the first input terminal, the second input terminal, and the first ground terminal, respectively;
a first switch configured to disconnect the first input terminal from the first output terminal, and a second switch configured to disconnect the first ground terminal from the second ground terminal.

2. The power cable of claim 1, wherein the first switch is included in the power input.

3. The power cable of claim 1, wherein the second switch is included in the power output.

4. The power cable of claim 1, wherein at least one of the first switch and the second switch comprise a slide switch configured to interrupt the connection.

5. The power cable of claim 1, wherein the first input terminal is applied with a varying electric potential.

6. The power cable of claim 1, further comprising:
a connector comprising a first connection line connecting the first input terminal and the first output terminal, a second connection line connecting the second input terminal and the second output terminal, and a ground line connecting the first ground terminal and the second ground terminal.

7. The power cable of claim 6, wherein the first switch is configured to disconnect the first input terminal from the first output terminal by interrupting the first connection line.

8. The power cable of claim 6, wherein the second switch is configured to disconnect the first ground terminal from the second ground terminal by interrupting the ground line.

9. An imaging apparatus comprising:
a power cable comprising:
a power input comprising a first input terminal, a second input terminal, and a first ground terminal;
a power output comprising a first output terminal, a second output terminal, and a second ground terminal, which are connected to the first input terminal, the second input terminal, and the first ground terminal, respectively;
a first switch configured to disconnect the first input terminal from the first output terminal, and a second switch configured to disconnect the first ground terminal from the second ground terminal; and
a main unit connected to the power output of the power cable and configured to be supplied with power through the power cable.

10. The imaging apparatus of claim 9, wherein the first switch is included in the power input of the power cable.

11. The imaging apparatus of claim 9, wherein the second switch is included in the power output of the power cable.

12. The imaging apparatus of claim 9, wherein at least one of the first switch and the second switch comprises a slide switch configured to interrupt the connection.

13. The imaging apparatus of claim 9, wherein the first input terminal is applied with a varying electric potential.

14. The imaging apparatus of claim 9, wherein the power cable further comprises a connector comprising a first connection line connecting the first input terminal and the first output terminal, a second connection line connecting the second input terminal and the second output terminal, and a ground line connecting the first ground terminal and the second ground terminal.

15. The imaging apparatus of claim 14, wherein the first switch is configured to disconnect the first input terminal from the first output terminal by interrupting the first connection line.

16. The imaging apparatus of claim 14, wherein the second switch is configured to disconnect the first ground terminal from the second ground terminal by interrupting the ground line.

17. An electronic device comprising:
a power cable comprising:
a power input comprising a first input terminal, a second input terminal, and a first ground terminal;
a power output comprising a first output terminal, a second output terminal, and a second ground terminal connected to the first input terminal, the second input terminal, and the first ground terminal, respectively;
a first switch configured to disconnect the first input terminal from the first output terminal, and a second switch configured to disconnect the first ground terminal from the second ground terminal; and
a main unit connected to the power output of the power cable and configured to be supplied with power through the power cable.

18. The electronic device of claim 17, wherein the first switch is included in the power input of the power cable.

19. The electronic device of claim 17, wherein the second switch is included in the power output of the power cable.

20. The electronic device of claim 17, wherein at least one of the first switch and the second switch comprises a slide switch configured to interrupt the connection.

21. The electronic device of claim 17, wherein the first input terminal is applied with a varying electric potential.

22. The electronic device of claim 17, wherein the power cable further comprises a connector comprising a first connection line connecting the first input terminal and the first output terminal, a second connection line connecting the second input terminal and the second output terminal, and a ground line connecting the first ground terminal and the second ground terminal.

23. The electronic device of claim 22, wherein the first switch is configured to disconnect the first input terminal from the first output terminal by interrupting the first connection line.

24. The electronic device of claim 22, wherein the second switch is configured to disconnect the first ground terminal from the second ground terminal by interrupting the ground line.

25. A large format display (LFD) comprising:
a plurality of displays that are combined to display a single image, each display comprising a respective power cable comprising:
a three-prong power input configured to connect to the respective display to an electrical outlet;
a three-prong power output corresponding to the three-prong power input, the three prong power out being configured to connect to the respective display;
a first terminal, a second terminal, and a ground terminal, which respectively connect corresponding prongs of the three-prong power input and the three prong power output,
a first switch included in the first terminal and being configured to interrupt power of the first terminal, while the respective power cable is plugged into the electrical outlet.
